(19) United States
(12) Patent Application Publication
(10) Pub. No.: US 2002/0187325 A1
(43) Pub. Date: Dec. 12, 2002

(54) Recording material for card and card using the same

(75) Inventors: Noriyoshi Umeta, Fuji (JP); Takeshi Kanazaki, Fuji (JP)

Correspondence Address: ARMSTRONG,WESTERMAN & HATTORI, LLP, 1725 K STREET, NW., SUITE 1000, WASHINGTON, DC, 20006, US

(73) Assignee: Nisshinbo Industries, Inc., Tokyo (JP)

(21) Appl. No.: 10/100,062

(22) Filed: Mar. 19, 2002

(30) Foreign Application Priority Data
Mar. 21, 2001 (JP) 2001-080620

(51) Int. Cl. B32B 7/02

(52) U.S. Cl. 428/217; 428/220; 428/480; 428/483

(57) ABSTRACT

To present a recording material for card excellent in resistance to abrasion, hardly leaving folding crease, and having an adequate rigidity, and various cards using such recording material considering environmental effects, such as scratch card excellent in information concealing performance. A base material composed of one layer or two or more layers in a thickness of 800 μm or less, of which maximum displacement measured by a nano indentation tester when a load of 4.9 mN is held for 1 second by using a triangular pyramid indenter is 1.1 μm or more, void content is 25% or less, and rigidity is 4 mN or more.

### BACKGROUND OF THE INVENTION

1. Field of the Invention

The present invention relates to a recording material for card, and a card using this recording material, and more particularly to a recording material for card excellent in resistance to abrasion, hardly leaving folding creases, having proper rigidity, and small in environmental effects, and a card using this recording material.

2. Description of the Related Art

Various cards are hitherto manufactured depending on the purposes, such as prepaid card, member's card, lottery card, ID card, and telephone card. Besides, various functions and configurations are given depending on the applications, and there are, for example, cards having a magnetic recording layer for recording magnetic information, cards having writing surface for writing the name by the card holder or a recording layer for recording visible information, and so-called scratch cards having the recorded visible information concealed by a removable concealing layer.

These cards are often used repeated for a long period, and are frequently inserted and removed in and from pockets or card holders such as commuter's tickets and bank card, or loading into reading machines. Accordingly, these cards are required to have a sufficient resistance to abrasion on the recording layer on which visible information is recorded or on the surface.

In the field of scratch card, when removing the concealing layer by using a coin or the like, resistance to abrasion is particularly important in order that the recording layer or its surface recording the concealed visible information may not be removed by scratching.

To enhance the resistance to abrasion, hitherto, various methods have been developed, such as a method of reinforcing the adhesion between the ink of the recorded visible information and the recording layer, a method of reinforcing the adhesion between the recording layer and base material, and a method of reinforcing the strength of the recording layer itself. It was, however, difficult to satisfy these contradictory properties at the same time, such as the reinforcement of adhesion, increase of strength of recording layer itself, and enhancement of printability. In the field of scratch cards, by forming a concealing layer that can be removed easily, strong abrasion is prevented. However, if an easily removable concealing layer is provided, the concealing layer may be peeled off by friction during transportation.

On the other hand, the cards used repeatedly for a long period may be folded and creased when handled by the user, or loaded into a reading machine. Such crease or folding crease posed problems. Aside from the problem of crease, the rigidity is also required in consideration of handling by machine. To satisfy these requirements, base materials are selected in proper type and thickness depending on the application, among vinyl chloride or polyester films, sheets or paper sheets. However, the reference of the folding strength and required rigidity capable of securely preventing folding crease has not been clarified, manufactured cards were not ideal to satisfy all these requirements.

Recently, moreover, as the consciousness of environmental problems is heightening, effects of discarded materials on the environments are much discussed. Cards are no exception, and it is required to use a biodegradable material in the base material of cards. Cards having a biodegradable material contained in the base material are being developed, but are not designed to have the properties of resistance to abrasion, strength and rigidity at the same time.

In the field of scratch cards, aside from the problem of resistance to abrasion, there was a problem of revealing of the information to be concealed without removing the concealing layer, and an advanced concealing performance is requested, but the measure is not sufficient at the present.

Therefore, the recording material for card was studied in the light of the problems in the conventional cards, and the problem that the invention is to solve is to present a recording material for card excellent in resistance to abrasion, hardly leaving folding crease, and having a proper rigidity, and also present various cards using this recording material in consideration of environmental effects, such as scratch cards excellent in information concealing performance.

### SUMMARY OF THE INVENTION

To solve the problems, the invention presents a recording material for card, being made of a base material composed of one layer or two or more layers in a thickness of 800 μm or less, of which maximum displacement measured by a nano indentation tester when a load of 4.9 mN is held for 1 second by using a triangular pyramid indenter is 1.1 μm or more, void content is 25% or less, and rigidity is 4 mN or more.

In the composition of the card of the invention intended to solve these problems, visible information is recorded at least on one side of the recording material for card.

As a result of intensive studies, the present inventors discovered that the recording layer or the information of characters or the like recorded in the layer is hardly erased, that is, the resistance to abrasion is achieved, when the base material has a certain degree of cushion property, and that folding crease is hardly left over when the void content of the base material is smaller than a specific value. Further, when the rigidity is more than a specific value, it is known to withstand sufficiently if passed in the reading machine frequently, and when these properties are combined adequately, a recording material for card having an excellent performance is obtained, and it is also learned that a card of an excellent performance not found in the prior art can be manufacturing by using such recording material, and thereby the invention is completed.

In addition to the composition mentioned above, the invention may also comprise a receptor layer of recording medium provided at least on one side of the base material. It may also comprise a layer of which maximum displacement measured by a nano indentation tester when a load of 4.9 mN is held for 1 second by using a triangular pyramid indenter is less than 1.1 μm, and this layer occupies 30% or more of the sectional area by cutting the recording material for card in the thickness direction. Further, a biodegradable resin is contained in the layer. The card may be also presented as a scratch card, and the ink surface printing visible information to be concealed is nearly flush with the recording surface for printing the same information.

### DESCRIPTION OF THE PREFERRED EMBODIMENTS

An example of recording material for card of the invention is explained below.

In the present invention, the term “recording material for card” indicates a base material itself in a case that any layers are not laminated, and it indicates a base material and layers in a case that the layers are laminated. The base material is a sheet of various materials, or plastic film or sheet, including single-layer structure and multilayer structure. Laminated layers are layers laminated by various means such as coating applied on the base material for the purpose of enhancing the printability, improving the appearance, or protecting the surface. Further, when image, character information and other visible information is recorded on the layer to be usable for the final application, it is called a card.

The base material of the invention is required to have a proper cushion property. Therefore, its maximum displacement measured by a nano indentation tester when a load of 4.9 mN is held for 1 second by using a triangular pyramid indenter should be 1.1 μm or more. A nano indentation tester usable for such measurement is, for example, Elionix ENT-1100a manufactured by Elionix Inc. Using this tester, the present inventors measured by dividing in 250 steps at edge interval of indenter of 115 deg. Since the maximum displacement is 1.1 μm or more, the surface of the recording material for card or the recorded information is hardly erased when abraded. More preferably, the maximum displacement should be 1.5 μm or more.

The base material of the invention is required to have a void content of 25% or less. Accordingly, stripe marks known as folding creases are hardly left over when folded or bent. Preferably, the void content should be 19% or less.

The rigidity of the base material of the invention should be 4 mN or more. If less than 4 mN, a problem may be caused in conveying process in the reading machine or the like. Preferably, the rigidity should be 7 mN or more.

These requirements of maximum displacement, void content, and rigidity can be satisfied by selecting proper materials. Usually, the dependence on the base material is larger than on the laminated layers, and the base material should be selected carefully to use a material satisfying these requirements. For example, Crisper G2323, a tradename of polyester film of Toyobo co., Ltd is preferably used.

If the base material of the invention is thicker than 800 μm, it is hard to use as a card. Although the material is selected in consideration of rigidity, but although the rigidity is high, if it is due to an extreme thickness, not owing to the material property, it maybe hard to process. Therefore, the base material of the invention is required to be 800 μm or less in thickness.

In the recording material for card of the invention, as far as the conditions are satisfied, layers may not be laminated, that is, it may be realized by an only base material. Both the base material and the layer may be either a single layer structure or multilayer structure.

The base material is not particularly limited as far as the required conditions are satisfied, and paper, synthetic paper, and plastic film can be used, but the material is not limited to them alone. Examples of plastic film include polyethylene terephthalate, vinyl chloride, polypropylene, polystyrene, polycarbonate, and other general thermoplastic resin films. In particular, polyethylene terephthalate and vinyl chloride films are preferred from the viewpoint of rigidity and processability. Further, as mentioned below, biodegradable materials may be used.

A preferred example of the invention includes a layer playing the role of a core and a shock absorbing layer. Generally, when the cushioning performance is increased, process suitability and strength tend to be insufficient. Accordingly, by forming a layer playing the role of a core for enhancing the process suitability and strength, and also forming a shock absorbing layer for adding to cushioning performance, both cushioning performance and process suitability or strength may be satisfied. As the layer playing the role of core, in order to achieve its purpose, it is preferred to use a material of which maximum displacement measured by a nano indentation tester when a load of 4.9 mN is held for 1 second by using a triangular pyramid indenter is less than 1.1 μm. In spite of this material, if the thickness is insufficient, this role cannot be played, and it is preferred that the layer playing the role of the core may occupy 30% or more of the sectional area by cutting the recording material for card in the thickness direction. Both the core role playing layer and the shock absorbing layer may be the base material, or may be layers applied by coating. Considering the ease of processing, it is particularly preferred to adhere the shock absorbing sheet to the core role playing layer, or extrude it together with the core role playing layer.

The recording material for card of the invention may be either the base material alone, or a lamination of the base material and some layers. It is also a preferred example to contain a receptor layer of recording medium such as ink in the laminated layers in order to enhance suitability to printing or writing. Usually, the receptor layer of recording medium is provided on the outermost layer, but a surface protective layer having a property of passing ink may be provided on the receptor layer of the recording medium. This receptor layer may be provided on either one side or both sides of the base material.

Visible information is recorded in the receptor layer of the recording medium, and this method includes offset printing, silk screen printing, gravure printing, various printing methods, ink jet recording, heat transfer method, electrophotographic method, impact printer method, and writing by water-based ink, oil-based ink, and many others, and is not particularly limited. The visible information may be either the same content displayed in multiple cards, or different information in each card such as membership number. The information may be also recorded by the dealer of cards, and may be recorded by the user of the card such as the signature. The receptor layer of the invention is applicable to these cases, and is provided for the purpose of enhancing the ink absorbing property, drying performance, sharpness of printing and other required properties. The receptor layer in the invention can be applied by coating, spraying, immersion, etc. For example, it can be applied by air knife coater, bar coater, roll coater or other device. To enhance adhesion to the base material, further, it may be applied after anchor coat. As the ingredient, pigment, binder, and additive may be contained.

In the recording material for card of the invention, a biodegradable resin may be used in its forming material. The biodegradable resin in the invention is a compound low in combustion energy, not generating harmful gas, and metabolized in microorganism in the natural environment to be decomposed finally into water and carbon dioxide, and is a durable biodegradable plastic having no practical problem in the ambient atmosphere. Although not limited particularly, preferred examples include polylactic acid, starch+denatured PVA mixture, polybutylene succinate/adipate copolymer, polycaprolactone, polyhydroxy butyrate/valylate copolymer, and other plastics. In particular, polylactic acid is preferred from the viewpoint of quickness in decomposition and strength. As required, other plastics may be added for the purpose of enhancing the strength so far as the biodegradable property may not be sacrificed. A biodegradable resin may be also used in the base material or laminated layers. When forming a sheet or film by using a biodegradable material, voids may be formed inside by a method of adding gas or vaporizing substance and foaming by diffusion and extruding, a method of adding a substance generating gas by chemical decomposition, or a biaxial extruding method by adding other resin.

A card can be manufactured by using the recording material for card of the invention explained above. In particular, a mode adding visible information is preferred because the effect of the invention may be utilized effectively. In particular, a scratch card is particularly preferable. A general example of its manufacturing method is explained below. First, the password, winner or loser mark and others are printed on the recording material for card of the invention. A concealing layer is provided thereon. The concealing layer is made of a material which can be removed by scratching with a coin or nail. The card manufactured in this way is to obtain information by removing the concealing layer by the user, and it is used for purpose of prepaid card or lottery card. When manufactured by using the recording material for card of the invention, since it is excellent in resistance to abrasion, characters or receptor layers are not erased to be illegible when rubbed with a coin. Or the necessity of processing the receptor layer or concealing layer particularly for preventing such troubles is lowered, and the cost can be lowered. Further, by forming a shock absorbing layer on the layer playing the role of the core, and forming a receptor layer thereon, information can be also printed on the receptor layer.

In the scratch card, it is important that the information to be concealed by the concealing layer should not be revealed before the concealing layer is removed. For example, if the ink surface of characters recording the information to be concealed is convex or concave on the recorded surface, it may appear in relief if a concealing layer is formed thereon. This is a visible case, or it may be known by touching. To prevent such problem, the ink surface of printing characters is preferred to be nearly flush with the recording surface as seen from the side. For example, when printed by a laser printer, the toner is built up on the printed surface, and it is not suited to the purpose. In other recording method, if the ink is built up, or the impressed portion is embossed by pressure, it is not suited to the purpose. For printing flush with the recording surface, it is realized relatively easily by printing with an ink jet printer. The ink is absorbed by the recording material, and is not built up or impressed. Thus, by using the recording material for card of the invention, a scratch card can be manufactured by keeping the ink surface of characters recording the information to be concealed flush with the recording surface as seen from the side, so that an extremely excellent property is obtained.

To realize printing by ink jet printer, it is preferred to use a receptor layer suited to this printing. It is realized by various known methods, for example, coating method. In such a case, the receptor layer is preferred to contain a filler and a binder. Preferred examples of filler include silica, calcium carbonate, magnesium carbonate, diatom earth, talc, titanium oxide, and alumina sol, and they can be used either alone or in mixture. From the viewpoint of ink absorbing ability, synthetic silica is particularly preferred. Examples of binder include polyvinyl alcohol, polyvinyl butyral, gelatin, polyvinyl acetal, carboxy methyl cellulose, polyvinyl pyrrolidone, styrene-acrylic copolymer, ethylene-vinyl acetate copolymer, styrene-butadiene rubber, polyurethane, and acrylic resin. They can be used either alone or in mixture.

Explaining the manufacturing process of scratch card, the following method is known. That is, on the receptor layer, the visible information to be concealed such as ID number, lottery winner or loser mark and others is printed by using an ink jet recording printer. Then, on the visible information to be concealed, clear varnish or lacquer is applied as a protective layer. This protective layer protects when the visible information to be concealed is rubbed by a coin or the like, and also has a function of making the metal foil or the like easily come off but if inconvenience does not occur, the protective layer may be omitted. Further thereon, a concealing layer is provided. A metal foil may be used as the concealing layer. The material of metal foil may be selected from aluminum, copper, zinc, iron, gold, silver, or the like. The metal foil may be laminated by a method of transferring a metal foil formed by preliminarily evaporating on other support element, or it may be laminated directly by vacuum deposition. In the case of transfer, an adhesive layer is preliminarily provided on the side for adhering the metal foil, and it is laminated by heating while pressing, or an adhesive may be sprayed immediately before lamination. The metal foil may be a single layer, but multiple layers may be used if there is problem in concealing performance or strength. In the case of multiple layers, it is preferred to use a weak adhesive on the side contacting with the visible information to be concealed or the protective layer, and a strong adhesive on the side adhering the metal foil.

The invention has such configuration, and the recording material for card of the invention is excellent in resistance to abrasion, hardly leaving folding creases, and having a proper rigidity, and hence it is high in versatile use and can be used in various cards depending on the purpose. For example, it is preferably used in the bank card, commuter's ticket and others often removed from the pocket or card holder and loaded into a reading machine, or scratch card demanding a high resistance to abrasion.

When the base material and others of the recording material for card of the invention are made of a biodegradable resin, if burned after use, the combustion energy is low and the incinerator is not damaged, and harmful gas is not generated, and it is decomposed by microorganism in the natural environments, so that there is no adverse effect on the natural environments.

### EXAMPLES

Examples and comparative examples of the recording material for card of the invention are explained below. It must be noted, however, that the invention is not limited by the examples alone. In the following explanation, the “part” refers to the part by weight, and “%” is wt. % (except for void content), and “solid matter concentration” shows the rate of solid matter in the product.

The base materials used in the examples of the invention and comparative examples were selected from the base materials No. 1 to No. 6 shown in Table 1. These base materials of No. 1 to No. 6 may be used either alone as single-layer structure, or as multilayer structure by adhering two or more layers by using the following adhesive.

TABLE 1
[Base material]

| | Description, | Maker, | Thickness | |
|---|---|---|---|---|
| No. | type | brand | (μm) | Feature |
| 1 | Polyethylene | Toyobo | 188 | Maximum |
| | terephthalate | co., Ltd, | | displacement: 1.61 μm |
| | film | Crisper | | Void content: 18.5% |
| | containing | G2323 | | Rigidity: 7.6 mN |
| | micro voids | | | |
| 2 | Thermoplastic | Nisshinbo | 50 | Maximum |
| | polyurethane | Industries. | | displacement: 2.3 μm |
| | film | Inc, | | Void content: 0% |
| | | Polyurethane | | |
| | | Elastomer | | |
| | | Film | | |
| 3 | White | Toray | 250 | Maximum |
| | polyethylene | Industries. | | displacement: 1.05 μm |
| | terephthalate | Inc, | | Void content: 12.1% |
| | film | Lumirroar | | Rigidity: 21 mN |
| | | E22 | | |
| 4 | Polylactic | Mitsubishi | 50 | Maximum |
| | acid film | Plastics. | | displacement: 1.48 μm |
| | containing | Inc, Ecoloju | | Void content: 14.9% |
| | micro voids | SFPT | | |
| 5 | White | Mitsui | 250 | Maximum |
| | polylactic | Chemicals. | | displacement: 1.05 μm |
| | acid film | Inc, Laycea | | Void content: 15.5% |
| | | TOF | | Rigidity: 16 mN |
| 6 | Polyethylene | Toray | 188 | Maximum |
| | terephthalate | Industries. | | displacement: 2.13 μm |
| | film | Inc, E60L | | Void content: 58.9% |
| | containing | | | Rigidity: 4.7 mN |
| | micro voids | | | |

Further, as an anchor coat, the following composition was applied on the base material selected from Table 1 in a dry film thickness of 5 μm.

[Liquid Composition of Anchor Coat]

Acrylic binder

(BASF Dispersions, Acronal YJ6221D, solid content 49%) 100 parts

An adhesive of the following composition was applied on the adhesive surface of base material in a dry coating weight of 3 g/m2.

[Composition of Adhesive]

Polyurethane emulsion

(Takeda Chemical Industries, Takelac W-7004, solid content 33%) 60 parts

Hardener (Takeda Chemical Industries, Takelac AW-725, solid content 100%) 10 parts

Water 50 parts

A receptor layer of recording medium, herein as receptor layer of ink, in the following composition was applied on the anchor coat in a dry thickness of 20 μm.

[Liquid Composition of Ink Receptor Layer]

Binder (polyester resin)

(Toyobo co., Ltd , Vylonal MD1200, solid content 34%) 100 parts

Filler (silica) (Mizusawa Industrial Chemicals, Mizukasorb C-1, solid content 100%) 25 parts

Water 70 parts

### Example 1

The anchor coat was applied on the base material No. 1 in Table 1, and the ink receptor layer of the specified composition was applied, and a first example of recording material for card of the invention was obtained. Characters were impressed on this recording material by using water-based stamp (by Shachihata Inc,), and the characters were transferred sharply without any missing part.

### Example 2

A second example of recording material for card of the invention was obtained in the same procedure as in example 1, except that the base materials of No. 2 and No. 3 were used instead of base material No.1 in example 1, and adhered by using the specified adhesive. The thickness of the base materials obtained by adhesion was 302 μm. At this time, the maximum displacement of the base material was 2.3 μm, the void content was 10.1%, and the rigidity was 21 mN. When the obtained recording material was cut in the thickness direction, the rate of the base material No. 3 was more than 3% of the sectional area.

### Example 3

A third example of recording material for card of the invention was obtained in the same procedure as in example 1, except that the base materials of No. 4 and No. 5 were used instead of base material No.1 in example 1, and adhered by using the specified adhesive. The thickness of the base materials obtained by adhesion was 302 μm. At this time, the maximum displacement of the base material was 1.48 μm, the void content was 15.4%, and the rigidity was 16 mN. When the obtained recording material was cut in the thickness direction, the rate of the base material No. 5 was more than 30% of the sectional area.

### Comparative example 1

A first comparative example of recording material for card was obtained in the same procedure as in example 1, except that the base material No. 5 was used instead of base material No. 1 in example 1.

### Comparative Example 2

A second comparative example of recording material for card was obtained in the same procedure as in example 1, except that the base material No. 6 was used instead of base material No. 1 in example 1.

The performance of these recording materials for card was measured by the following methods.

[Measurement of Physical Data]

(1) Maximum displacement

Using a nano indentation tester Elionix ENT-1100a (Elionix Inc.), a load of 4.9 mN was held for 1 second by using a triangular pyramid indenter, and the maximum displacement was measured. The edge interval of the indenter was 115 degrees, and it was measured by dividing in 250 steps.

(2) Void content

Using a scanning electron microscope S-2460N (Hitachi, Ltd.), the base material was magnified arbitrarily by 300 to 1,500 times, and the section was photographed, the void area of the section was marked and processed by image processing software Win ROOF (Mitani Corporation), and the sum of the void area in the viewing field of the base material was calculated, and the void content was determined in the following formula. This method can be applied not only in a base material of single layer structure, but also in a base material of multilayer structure.

Void content (%)−sum of void area (μm²)/viewing field area (μm²)×100 Formula 1

(3) Rigidity

Gurley stiffness was measured by J. TAPPI No. 40.

The performance of recording materials measured in these methods was evaluated as follows.

[Evaluation]

(1) Resistance to abrasion by coin

Characters were impressed on the receptor layer by water-based stamp (by Shachihata Inc,), and when the characters were completely dried, the character portion was scratched by a 100-yen coin, and the performance was evaluated as ⊚ when scratch of character or defect of receptor layer was not observed, ◯ when slight scratch of character or defect of receptor layer was noted but the characters were legible, and X when characters and receptor layer were erased and characters were illegible.

(2) Resistance to folding crease

The recording material for card was folded at right angle, it was evaluated as ⊚ when no folding mark was recognized, ◯ when folding mark was noted but crease was not formed and there was no practical problem, and X when folding mark was formed as crease.

(3) Biodegradable property

The recording material for card was buried in the farm soil for 5 months, and it was evaluated as ◯ when decomposed until the original shape was not maintained, and X when hardly decomposed. Results of evaluation are shown in Table 2.

TABLE 2

| | Coin | Folding | |
|---|---|---|---|
| | abrasion | crease | Decomposition |
| Example 1 | ⊚ | ◯ | X |
| Example 2 | ⊚ | ⊚ | X |
| Example 3 | ◯ | ◯ | ◯ |
| Comparative | X | ◯ | ◯ |
| example 1 | | | |
| Comparative | ⊚ | X | X |
| example 2 | | | |

What is claimed is:

1. A recording material for card, being made of a base material composed of one layer or two or more layers in a thickness of 800 μm or less, of which maximum displacement measured by a nano indentation tester when a load of 4.9 mN is held for 1 second by using a triangular pyramid indenter is 1.1 μm or more, void content is 25% or less, and rigidity is 4 mN or more.

2. The recording material for card of claim 1, wherein a biodegradable resin is contained in the layer.

3. A recording material for card, being made of a base material composed of one layer or two or more layers in a thickness of 800 μm or less, of which maximum displacement measured by a nano indentation tester when a load of 4.9 mN is held for 1 second by using a triangular pyramid indenter is 1.1 μm or more, void content is 25% or less, and rigidity is 4 mN or more, wherein a receptor layer of recording medium is provided at least on one side of the base material.

4. The recording material for card of claim 3, wherein a biodegradable resin is contained in the layer.

5. The recording material for card of claim 1, further including a layer of which maximum displacement measured by a nano indentation tester when a load of 4.9 mN is held for 1 second by using a triangular pyramid indenter is less than 1.1 μm, wherein said layer occupies 30% or more of the sectional area by cutting the recording material for card in the thickness direction.

6. The recording material for card of claim 5, wherein a biodegradable resin is contained in the layer.

7. The recording material for card of claim 3, further including a layer of which maximum displacement measured by a nano indentation tester when a load of 4.9 mN is held for 1 second by using a triangular pyramid indenter is less than 1.1 μm, wherein said layer occupies 30% or more of the sectional area by cutting the recording material for card in the thickness direction.

8. The recording material for card of claim 7, wherein a biodegradable resin is contained in the layer.

9. A card characterized by recording visible information at least on one side of a recording material for card in any one of claims 1 to 8.

10. The card of claim 9, wherein the card is a card for scratch, and the ink surface printing visible information to be concealed is nearly flush with the recording surface for printing the same information.
